(19) United States
(12) Patent Application Publication
(10) Pub. No.: US 2012/0082509 A1
(43) Pub. Date: Apr. 5, 2012

(54) INTERFACE DEVICES AND METHODS OF USING THE SAME

(76) Inventors: Brian Belcher, Brownsburg, IN (US); Louis B. Schiesz, Fishers, IN (US); Matthew Scott Graham, Noblesville, IN (US)

(21) Appl. No.: 13/099,121

(22) Filed: May 2, 2011

Related U.S. Application Data
(60) Provisional application No. 61/330,378, filed on May 2, 2010.

(51) Int. Cl. F16B 7/18; F16B 7/00

(52) U.S. Cl. 403/343; 403/345

(57) ABSTRACT

A housing is disclosed having ends capable of receiving tool head interfaces and tool handle interfaces. One of the ends can be configured as a specialized interface end and the other end can be configured as a standardized interface end. One example of a standardized interface end is a threaded interface. An example of the specialized interface end is a selectively engaged end having a plurality of detents for variable positioning of the tool head end relative to the tool handle end.

### CROSS-REFERENCE TO RELATED APPLICATIONS

This application claims the benefit of U.S. Provisional Application No. 61/330,378 filed May 2, 2010, which is incorporated herein by reference in its entirety.

### TECHNICAL FIELD

Embodiments of the present invention relate generally to tool interface devices, and more particularly but not exclusively relates to paint brush adapters.

### BACKGROUND

Paint brushes that are connectable to a paint brush handle with a selectable engagement device provide added convenience for the user, and allow the user to replace a smaller portion of the paint brush after use, to change paint brush heads during a job, or to more easily clean the paint brush. Some tools, including paint brushes, are already provided with an interface, such as a threaded interface, that is not compatible with a selectable engagement device. Therefore, it is desirable to have a device to interface standardized tool heads or accessories with specialized tool handles. Alternatively, it is desirable to have a device to interface standardized tool handles with specialized tool heads.

### BRIEF DESCRIPTION OF THE FIGURES

FIG. 1 is a perspective view illustrating one embodiment of a tool having a handle that is detachable from an accessory.

FIG. 2 is a perspective view illustrating another embodiment of a tool having a handle that is detachable from an accessory.

FIG. 3 is a perspective view illustrating a selectable engagement device useful in detachably securing the handle to the accessory.

FIG. 4 is a perspective view illustrating yet another embodiment of a handle that is detachable from an accessory.

FIGS. 5-7 are perspective views illustrating some embodiments of accessories that may be detachably secured from the handle shown in FIG. 4.

FIG. 8 is an exploded perspective view of the handle shown in FIG. 4, according to one embodiment.

FIGS. 9-11 are perspective views of still other embodiments of a tool having a handle that is detachable from various accessories.

FIG. 12 is a side elevation view of another embodiment of a tool having an engagement mechanism.

FIG. 13 is a partial cross-section view of the engagement mechanism shown in FIG. 12.

FIGS. 14 and 16 show cross-section views illustrating an exemplary operation of the engagement mechanism shown in FIGS. 12 and 13.

FIGS. 15A and 15B are side and end elevation views, respectively, illustrating a one embodiment of a plunger.

FIGS. 17 and 18 are cross-section views illustrating an exemplary operation of a plunger-engaging assembly that may be incorporated within the engagement mechanism shown in FIGS. 12-14 and 16, according to one embodiment.

FIG. 19 is a perspective view illustrating an adapter according to one embodiment.

FIG. 20 is an exploded perspective view of the adapter shown in FIG. 19.

FIG. 21 is a cross-section view of the adapter shown in FIG. 19.

### DETAILED DESCRIPTION

For purposes of promoting an understanding of the principles of the invention, reference will now be made to the embodiments illustrated in the drawings and specific language will be used to describe the same. It will nevertheless be understood that no limitation of the scope of the invention is thereby intended, such alterations and further modifications in the illustrated device, and such further applications of the principles of the invention as illustrated therein being contemplated as would normally occur to one skilled in the art to which the invention relates.

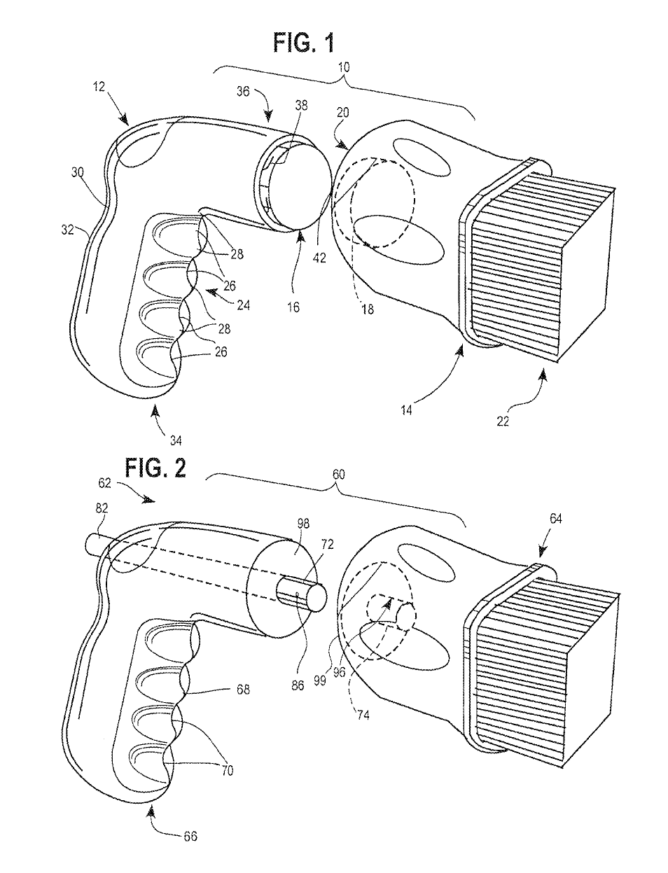

FIG. 1 is a perspective view illustrating one embodiment of a tool having a handle that is detachable from an accessory.

Referring to FIG. 1 a tool 10 includes a handle 12 and an accessory 14 (e.g., a brush head). Handle 12 is illustratively formed to have a protrusion 16 that is configured to mate with recess 18 formed in connecting end 20 of brush head 14. Brush head 14 also has a brush end 22 that provides filaments or hairs for use in applying paint to a surface. It should be understood that although the illustrations show a fairly broad brush of a width considerably larger than that of the handle 12, other brush head shapes and modifications are within the scope of the disclosure, and brush head 14 may have a differently shaped or smaller profile. In addition, the accessory 14 may be provided as a paint roller, sponge, edger, foam applicator, texturing applicator, cloth applicator, or the like, instead of as a brush head.

Handle 12 illustratively includes a contoured finger-grip surface 24 having a plurality of finger-receiving recesses 26. In the illustrated embodiment, finger-receiving recesses 26 cooperate with a plurality of rims 28 positioned therebetween so as to form a grip that is comfortable and substantially conforms to the contours of a human hand. As illustrated, a contoured surface 30 may also be provided on the palm-side surface 32 of handle 12. Handle 12 may also be configured to fit either a left-handed grip or a right-handed grip by having an exterior surface that is contoured to the corresponding grip.

Although FIG. 1 shows a handle 12 that is substantially formed in a 90-degree angle, it should be understood that other configurations are within the scope of the disclosure. Such configurations may be implemented as required by the particular use. For example, it may be advantageous for a handle 12 to have a less than 90-degree angle in certain applications. This configuration may be desirable for greater comfort, and/or for ease in accessing the area to be painted. In the alternative, handle 12 may be configured to have a pivotable angle (not shown), which would allow for a range of angles between grip portion 34 and engagement portion 36.

In the embodiment illustrated in FIG. 1, protrusion 16 is cylindrically shaped and has a smaller outer diameter than engagement portion 36. Protrusion 16 extends outwardly away from engagement portion 36 a sufficient length to permit a secure connection between male protrusion 16 and female connecting end 20 of brush head 14.

Connecting end 20 of brush head 14 is illustratively formed to have a cylindrically shaped recess 18, the recess being configured to receive male protrusion 16. Protrusion 16 has at least one groove 38 formed in the external surface 40 of protrusion 16. Groove 38 is configured to receive a tab 42 that is illustratively positioned on the interior of cylindrically shaped recess 18. Multiple tabs 42 may also be placed along the interior of cylindrically shaped recess 18 in order to mate with a protrusion having a plurality of grooves 38. Of course, it should be understood that tool 10 may be configured such that protrusion 16 is located on brush head 14 and recess 18 is located on handle 12.

If a plurality of groove 38 and tab 42 combinations are used, as shown in FIG. 1, brush head 14 can be connectable with handle 12 in a number of orientations. For example, brush head 14 could be aligned with handle 12 in the manner shown in FIG. 1, where brush head 14 is substantially co-planar with handle 12. In the alternative, however, brush head 14 could be rotated relative to handle 12 such that tabs 42 each align with a different groove, permitting alignments of brush head 14 and handle 12 that are not co-planar. Such varying alignments may be desirable for projects which are better facilitated by having a different angle of attack for the brush head 14.

Another embodiment is shown in FIG. 2, wherein a tool 60 comprises a handle 62 and an accessory 64 (e.g., a brush head). In the embodiment shown in FIG. 2, a grip portion 66 can be configured similarly to grip portion 34 of handle 12 in FIG. 1. For example, grip portion 66 of FIG. 2 may include finger-receiving recesses 70 that are bounded by rims 68. Furthermore, grip portion 66 may be configured to fit either a left hand or a right hand of a user.

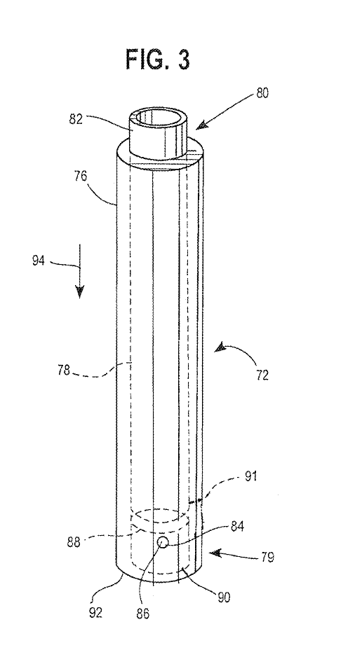

In the embodiment disclosed in FIG. 2, handle 62 and brush head 64 are connectable via selectable engagement device 72 and receiver 74. Selectable engagement device 72 is illustratively a cylindrical tube 76 having a movable rod 78 disposed therein, as can be seen in FIG. 3. Selectable engagement device 72 has a button end 80 housing a button 82 (visible in FIGS. 2 and 3). In the illustrated embodiment, button 82 is an exposed end of movable rod 78. The opposite, engagement end 79 of selectable engagement device 72 is enclosed and contains at least one aperture 84. A ball bearing 86 is positioned inside cylindrical tube 76 such that a portion of the ball bearing 86 extends outwardly through aperture 84. Outer surface 91 of rod 78 engages ball bearing 86, holding it in place against aperture 84.

A chamber 88 circumscribes rod 78, and a spring 90 is positioned between end cap 92 of cylindrical tube 76 and rod 78, thereby maintaining a bias against rod 78 to naturally predispose rod 78 in the position shown in FIG. 3. When button 82 is depressed, rod 78 moves in the direction indicated by arrow 94, depressing spring 90 against end cap 92. Such movement aligns chamber 88 with aperture 84, thereby allowing ball bearing 86 to partially recess inside chamber 88 and thereby not protrude as far through aperture 84. In this position, selectable engagement device 72 can be engaged or disengaged with receiver 74. Once selectable engagement device 72 is engaged with receiver 74 (and therefore handle 62 and brush head 64 are engaged), button 82 can be released, so as to cause ball bearing 86 to engage an inner surface 96 of receiver 74. In order to accommodate ball bearing 86, inner surface 96 may be fitted with a chamber or dimple (not shown) that receives ball bearing 86, or any similar type of construction that permits a locking engagement between selectable engagement device 72 and receiver 74. It is also contemplated that inner surface 96 may alternatively be formed of a malleable or other type of material that would allow for ball bearing 86 to imbed in inner surface 96 and thereby retain selectable engagement device 72 inside receiver 74.

A positioner (not shown) may also be used to facilitate engagement between handle 62 and brush head 64. Such a positioner may comprise, for example, matching engageable teeth that are formed on each of the surfaces of the handle 62 and brush head 64. The engageable teeth would be positioned such that when handle 62 and brush head 64 are engaged, the teeth would engage and therefore lock the rotational position of the brush head 64 in place relative to handle 62. The teeth may be positioned, for example, on engagement surface 98 of handle 62 and on the opposing engagement surface 99 of brush head 64. Another alternative construction is to place the teeth on or near end cap 92 of selectable engagement device 72, and mating teeth inside receiver 74.

In either embodiment, it may further be desirable to incorporate a liquid feed tube, or some other means of introducing liquid to the accessory 14 or 64. For example, it may be desirable to have a liquid feed tube that passes through the handle 12 or 62 to feed liquid to the accessory 14 or 64. As used herein, the term “liquid” can refer to paints, stains, washes, solvents, plasters, pastes and the like. The liquid feed tube may be connected to a liquid supply, or even a pressurized liquid supply capable of providing a constant source of liquid to the accessory 14 or 64. In the embodiment shown in FIGS. 2 and 3, such a liquid feed tube may be configured to pass through the center of rod 78. However, any other configurations may be provided as desired.

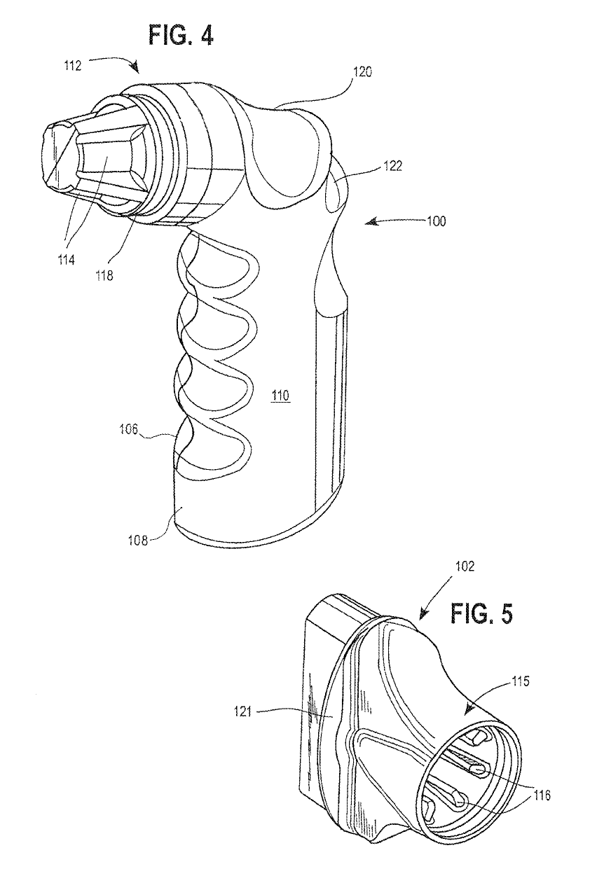

In yet another embodiment, a handle 100 and accessories 102 and 104 (e.g., brush heads) and 105 (e.g., a roller head) are disclosed in FIGS. 4-8. Handle 100 is illustratively formed of two substantially symmetric halves 106, 108, and the two halves are fastened with at least one fastener. A grip coating 110 is also disclosed, the grip being of a material that provides both comfort and utility as a grip. Such a material for the grip coating 110, for example, may be a polymer or rubberized type of material that is long-lasting and durable, yet has some flexibility so as to feel comfortable in the hand.

As shown in FIG. 4, handle 100 can be configured to have an engagement portion 112 that mates with receiving portion 115 of accessories 102, 104 or 105, shown in FIGS. 5-7. Illustratively, engagement portion 112 has recesses 114 that can mate with tabs 116 of accessories 102, 104, or 105. Recesses 114 cooperate with tabs 116 to create a mating relationship between handle 100 and a selected one of accessories 102, 104 or 105 such that accessories 102, 104 or 105 do not rotate relative to handle 100 when handle 100 and accessories 102 or 104 are engaged. Handle 100 also has a rim 118 that interlocks with head 102 to maintain the engagement between handle 100 and head 102.

As can be seen in FIGS. 4 and 8, handle 100 is illustratively configured to include a first thumb notch 120 and a second thumb notch 122. The alternative positions for the thumb in notch 120 or 122 allows for a range of hand sizes and/or a range of desired grips for a user.

FIG. 5 is an example of one type of accessory 102 (e.g., a brush head) that can be engaged with handle 100. In the example shown in FIG. 5, brush head 102 holds a two-inch paint brush. Such a two-inch paint brush is well known in the art, and is readily formed and attached to head 102 via staples, glue, or any other type of fastener.

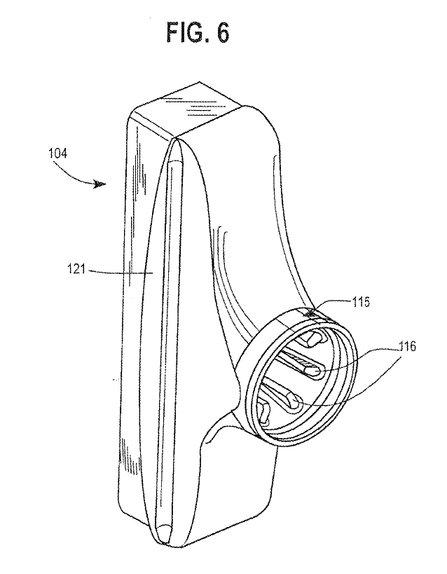

Yet another type of accessory 104 is shown in FIG. 6, wherein the brush head 104 holds a four-inch paint brush. In the illustrated embodiments shown in FIGS. 5 and 6, accessories 102 and 104 each include a protrusion 121 that provides a lip to facilitate easy detachment from handle 100.

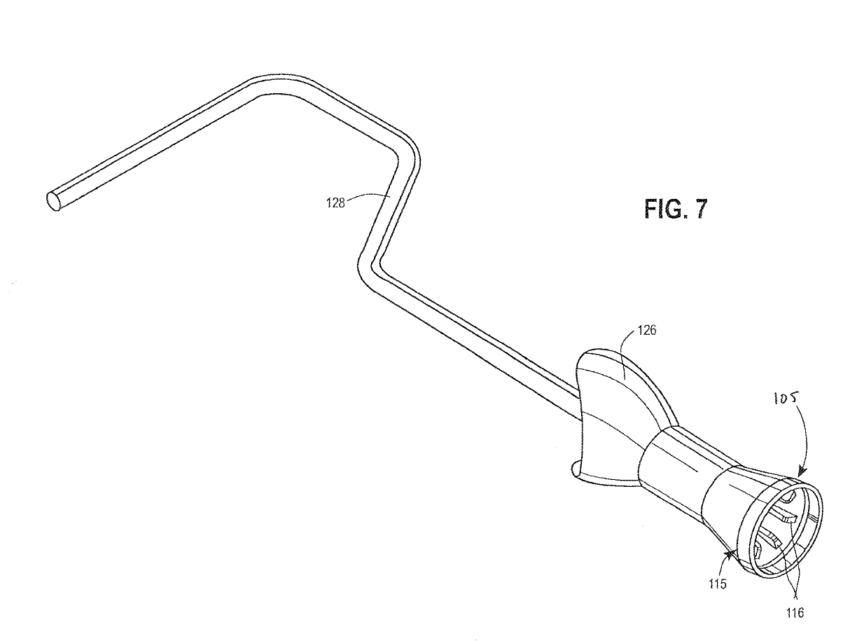

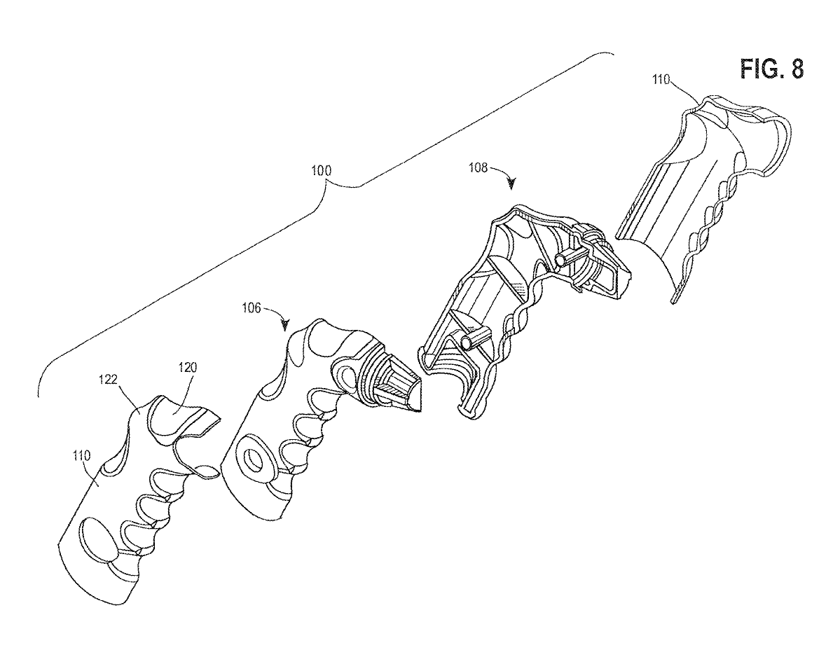

It is contemplated that an accessory such as roller head 105 shown in FIG. 7 may also be attached to handle 100. Roller head 105 may include a catch 126 that functions to prevent liquid from running down support 128 and onto the handle 100. Illustratively, support 128 is made of metal and is attached to a plastic head 105. Similar to accessories 102 and 104, roller head 105 has a receiving portion 115 that engages engagement portion 112 of handle 100.

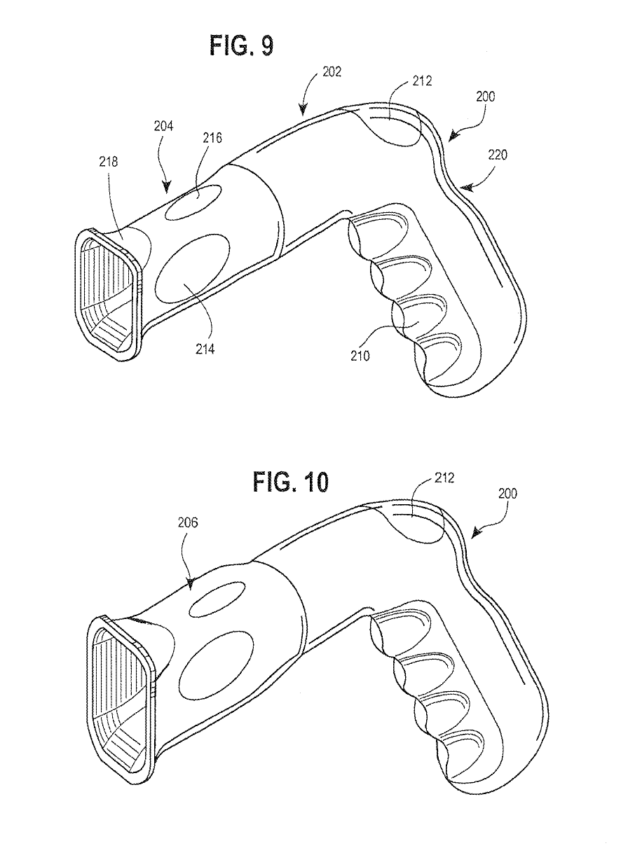

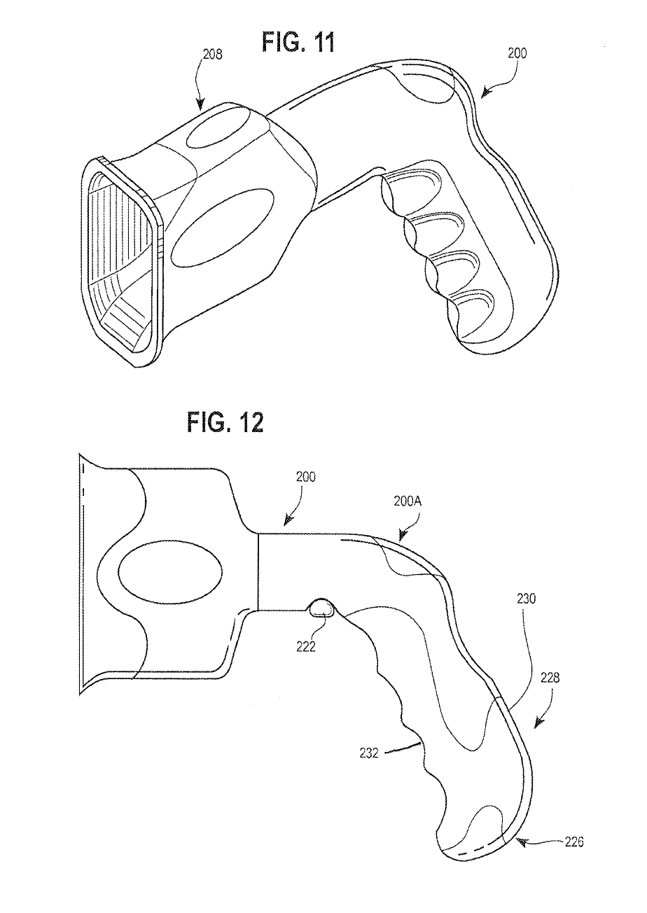

FIG. 9 shows yet another embodiment of a tool, which includes handle 200 and accessory 204. The handle 200 may be provided as similarly described with respect to handles 12 and 62. In this embodiment however, engagement portion 202 of handle 200 is relatively shorter than engagement portion 36 to allow a user to position his or her hand closer to the accessory and consequently have better control over the application process involving the accessory 204 (e.g., stroke of the paint brush, if the accessory is a brush head). Once again, accessory 204 is removable and replaceable with other types and sizes of accessories (e.g., paint brush heads 206 or 208, as can be seen in FIGS. 10 and 11).

Illustratively, handle 200 has grip surfaces 210 and 212 that can be formed from a material that is different from a material forming other surfaces of handle 200. For example, the grip surfaces 210 and 212 may be formed of a relatively soft material (e.g., a rubberized material) whereas the material forming other surfaces of handle 200 may be formed of a relatively hard material. Accordingly, the grip surfaces 210 and 212 may provide additional comfort and/or tackiness (assisting with grip) when a user is using the handle 200.

In one embodiment, portions or all of the tools and other devices disclosed herein, in addition to the packaging for the same, can be made of recyclable and/or biodegradable materials. For example, materials such as those available from www.goodearthpkg.com may be used.

Accessories 204, 206 and 208 may also be configured to have grip surfaces 214, 216 and 218 formed from materials as similarly described with respect to grip surfaces 210 and 212. Such grip surfaces 214, 216 and 218 are contemplated to assist a user with both removal and placement of the accessory, as well as rotation of the accessory as discussed further herein. Handle 200 may also have a recess 220 that is positioned to receive a portion of a user's hand.

As can be seen in FIG. 12, a tool may include handle 200A according to an alternative embodiment. Handle 200A may be provided in a similar manner as exemplarily described with respect to handle 200, and the engagement portion 202 may further include an engagement mechanism having a button 222. Further, the butt end 228 of handle 200 can be formed to have a rounded portion 226 that may also have a grip surface 230 extending from the finger groove portion 232. In one embodiment, the handle 200 shown in FIGS. 9-11 may also include an engagement mechanism having the button 222.

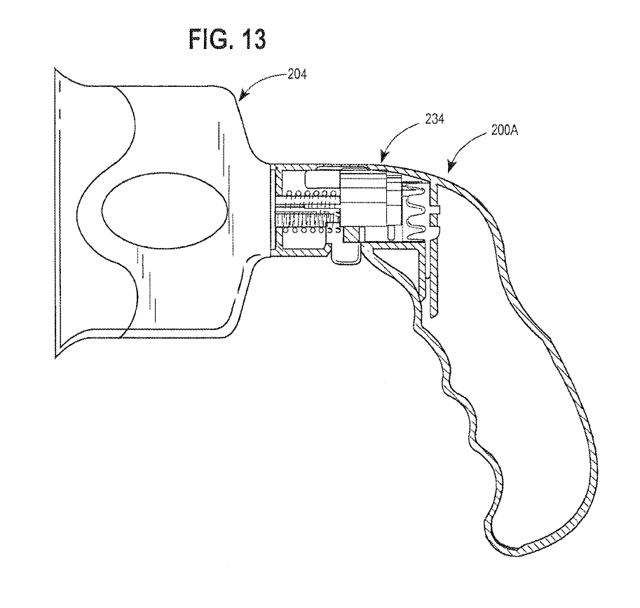

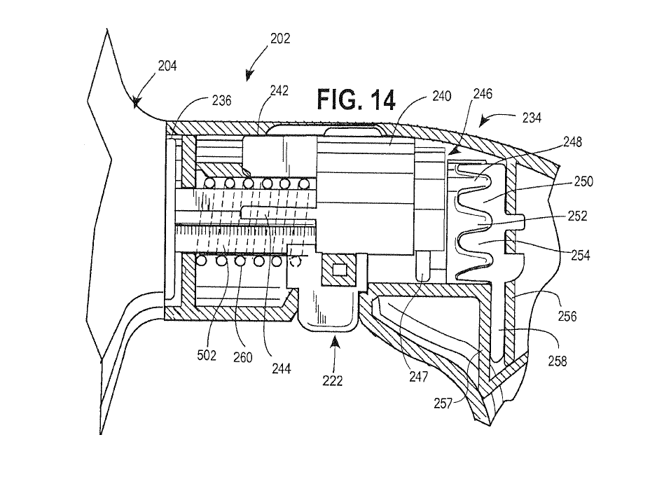

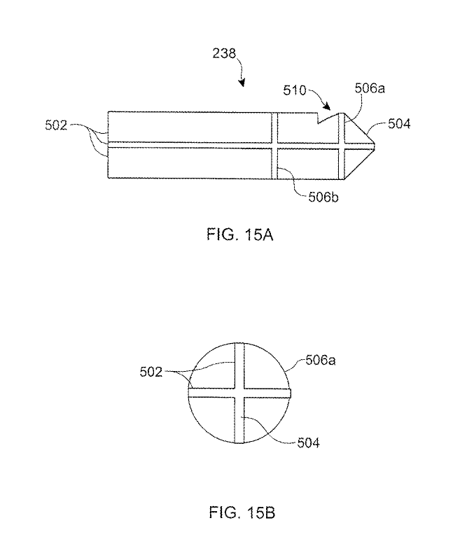

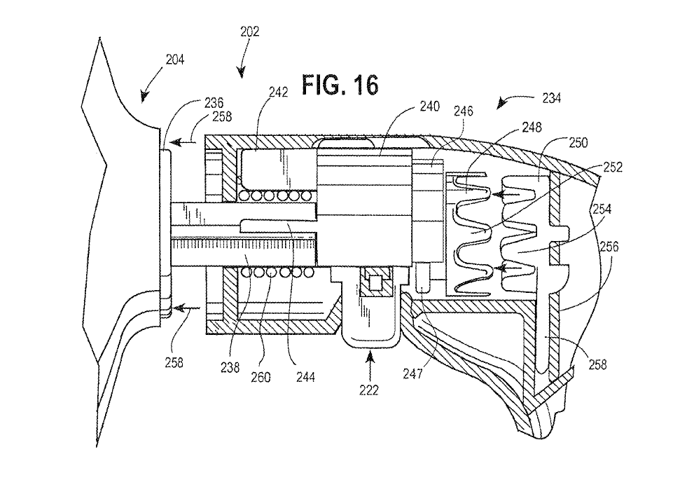

FIG. 12 is a side elevation view of another embodiment of a tool having an engagement mechanism. FIG. 13 is a partial cross-section view of the engagement mechanism shown in FIG. 12. FIGS. 14 and 16 show cross-section views illustrating an exemplary operation of the engagement mechanism 234 shown in FIGS. 12 and 13.

Referring generally to FIGS. 12-14 and 16, the engagement mechanism 234 is configured to allow an accessory 204 to be selectively rotated relative to the handle 200A depending on how the user engages the handle 200A and accessory 204. The accessory 204 includes a disc 236 and a plunger 238 extending away from the disk 236 along a longitudinal axis.

Referring to FIGS. 15A and 15B, the plunger 238 may include a plurality of fins 502 arranged such that, when viewed along the longitudinal axis, the fins 502 form a shape having a cross-section resembling a “+” shape. As shown in FIG. 15A, the fins 502 taper to somewhat of a point thereby forming inclined leading surfaces 504. The leading surfaces 504 facilitate insertion of the plunger 238 into the engagement mechanism 234. The plunger 238 may also include flanges 506a and 506b to provide structural support to the fins 502. It will be appreciated that the plunger 238 may include more or less flanges than those shown, or none at all. In one embodiment, a notch such as notch 510 may be formed in a fin 504. As illustrated, flange 506a is located between the leading surfaces 504 and the notch 510.

In one embodiment, the disc 236 may be integrally formed with the body of the accessory to form a single, integral piece. In another embodiment, the disc 236 may be formed as separate pieces which are subsequently coupled to the body of the accessory 204. In one embodiment, the plunger 238 may be integrally formed with, or separately formed and subsequently coupled to, the disc 236. Although only the accessory 204 is illustrated as including a disc 236 and a plunger 238 it will be appreciated that any accessory described herein may also include the disc 236 and plunger 238.

Referring back to FIG. 14, the engagement mechanism 234 includes a carriage 240, a first lock 248 and a second lock 250. The carriage 240 is configured to receive the plunger 238 and be coupled to the plunger 238 via a plunger-engaging assembly (not shown). When the carriage 240 is coupled to the plunger 238, the plunger can slide within the engagement portion 202, along the longitudinal axis of plunger 238. The carriage 240 includes tabs 242, 244 extending from a first end thereof toward accessory 204. Tabs 242 and 244 are configured to engage with guiding surfaces (not shown) within the engagement portion 202, thereby preventing the carriage 240 from undesirably rotating within the engagement portion 202. Carriage 240 also includes a cradle 246 extending from a second end thereof toward the second lock 250. The cradle 246 is configured to receive a guide rim 247 of the first lock 248. As discussed in greater detail below, the guide rim 247 is rotatable within the cradle 246.

In addition to the guide rim 247, the first lock 248 includes teeth 252 that can mesh with teeth 254 of the second lock 250. In one embodiment, the second lock 250 includes anchor members which extend through interior wall 256 of handle 200A, allowing the second lock to be positionally fixed within the engagement portion 202. In another embodiment, the second lock 250 may include a foot 258 extending between the interior wall 256 and a support member 257, allowing the second lock to be positionally fixed within the engagement portion 202. As will be discussed in greater detail below, the first lock 248 can also include a plunger-engaging portion (not shown) configured to engage with one or more surfaces of the fins 502 of plunger 238.

FIG. 14 illustrates one state of the engagement mechanism 234 in which the carriage 240 is coupled with the plunger 238 and the plunger 238 is fully inserted into the engagement mechanism 234. When the plunger 238 is fully inserted into the engagement mechanism 234, the plunger 238 is engaged with the plunger-engaging portion of the first lock 248 and teeth 252 and 254 become intermeshed. When teeth 252 mesh with teeth 254, the first and second locks 248 and 250 become engaged with each other. Because the second lock 250 is positionally fixed within the engagement portion 202, the first lock 252 is also is positionally fixed within the engagement portion 202 and cannot rotate. Accordingly, the plunger-engaging portion of the first lock 248 prevents the plunger 238 from substantially rotating within the carriage 240. When the plunger 238 is prevented from substantially rotating within the carriage 240, the accessory 204 is substantially prevented from rotating relative to the handle 200A.

FIG. 16 illustrates another state of the engagement mechanism 234 in which the carriage 240 is coupled with the plunger 238 but the accessory 204 (and, thus, the plunger 238) is being pulled away from the engagement portion 202, as indicated by arrows 258. Upon pulling the plunger 238, the carriage 240 slides within the engagement portion 202 along the direction indicated by arrows 258. Thus the cradle 246, which is engaged with the guide rim 247, acts to pull the first lock 248 away from the second lock 250. The separation of first and second locks 248 and 250 permits first lock 248 to rotate relative to second lock 250. This rotation allows a user to reposition accessory 204 at an angle of rotation appropriate for the application or user. Additionally a spring 260, which is connected between the carriage 240 and an interior wall of the engagement portion 202, becomes compressed as the carriage 240 slides along the direction indicated by arrows 258. Once the desired angle of rotation is achieved, the user can release accessory 204 so that first lock 248 returns to engagement with second lock 250. Upon release of the accessory 204, a restoring force provided by the compressed spring 260 biases carriage 240 to force the first lock 248 against the second lock 250 to engage second lock 250 absent action from a user.

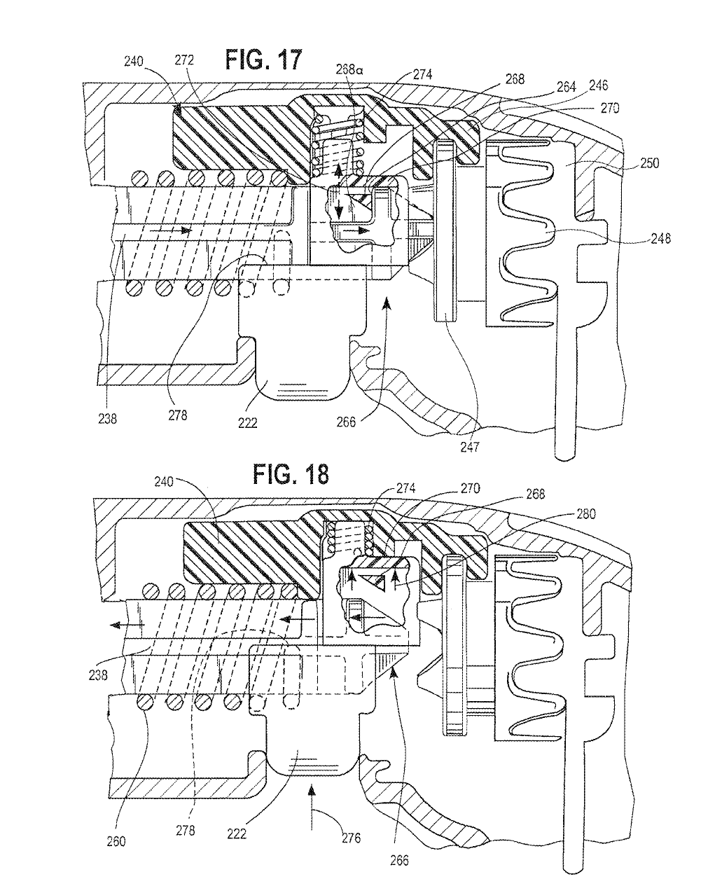

FIGS. 17 and 18 are cross-section views illustrating an exemplary operation of a plunger-engaging assembly that may be incorporated within the engagement mechanism shown in FIGS. 12-14 and 16, according to one embodiment.

Referring to FIGS. 17 and 18, a plunger-engaging assembly may, for example, include a retainer 268, a slider 270, and a spring 274. The retainer 268 is coupled to the slider 270 (e.g., at a location outside the plane of the cross-section view) and includes a surface 268a configured to be engaged by a leading surface 504 of the plunger 238. In one embodiment, the retainer 268 is integrally formed with the slider 270. Slider 270 is configured to move orthogonally relative to the longitudinal axis of the plunger 238 along the direction indicated by arrow 272. The spring 274 is connected between the slider 270 and an interior wall of the carriage 240. The button 222 is coupled to the slider 270. In one embodiment, the button 222 and the slider 270 are integrally formed. In other embodiments, the button 222 and the slider 270 are formed as separate pieces that may or may not be attached to each other. When the button 222 and the slider 270 are separately formed and are not attached to each other, the spring 274 acts to bias the slider 270 against the button 222. It will be appreciated, however, that the plunger-engaging assembly can be provided in any suitable manner.

Referring to FIG. 17, the plunger-engagement assembly can couple the carriage 240 with the plunger 238 when the plunger 238 is inserted into the engagement mechanism 234 such that a leading surface 504 contacts surface 268a of the retainer 268. As the plunger 238 is pushed further into the engagement mechanism 234, the leading surface 504 pushes against the surface 268a to thereby move the retainer 268 and slider 270 upwards along the direction indicated by arrow 272. When the plunger 238 is fully inserted into the engagement mechanism 234, the notch 510 is moved under the retainer 268 and the spring 274 biases the slider 270 and retainer 268 down into the notch 510. Upon disengaging the first lock 248 from the second lock 250 in the manner described above with respect to FIG. 16, the presence of the retainer 268 in the notch 510 of plunger 238 prevents the plunger 238 from being removed from the engagement member 234.

Referring to FIG. 18, the plunger 238 may be removed from the engagement member 234 when a user presses button 222 (e.g., in direction indicated by arrow 276). Upon pressing the button 222, the button 222 pushes against slider 270, urging it toward spring 274 (e.g., in the direction indicated by arrow 280) and ultimately compressing the spring 274. As the slider 270 moves, the retainer 268 moves in the same direction, and for the same distance. In this way, the retainer 268 can be pushed out of notch 510 of the plunger 238. After the retainer 268 is outside of notch 510, the plunger 238 can be withdrawn from the plunger-engaging assembly, out of the carriage 240, the engagement mechanism 234 and, ultimately, the handle 200A. Such a withdrawal may be appropriate if, for example, a user wants to replace accessory 204 with a different accessory, or otherwise dispose of accessory 204 while still being able to retain handle 200A.

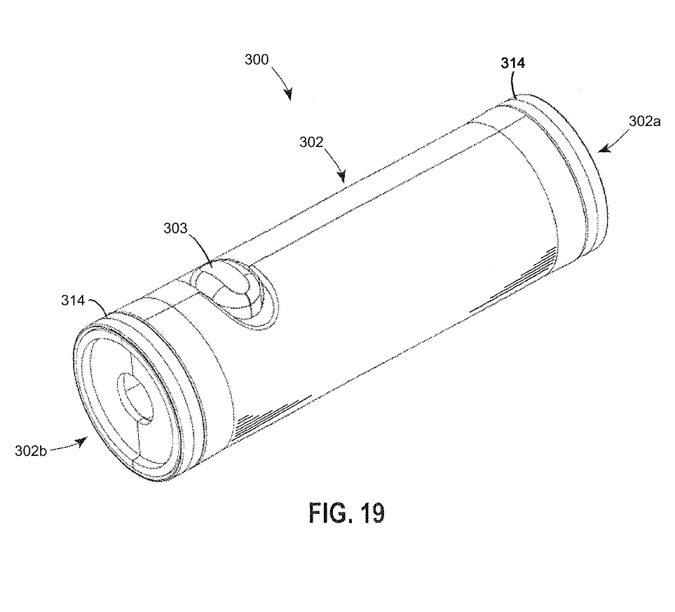

FIG. 19 is a perspective view illustrating an adapter according to one embodiment.

Referring to FIG. 19, and adapter, such as adapter 300, may be configured to connect to a handle (not shown) at one end thereof and to connect to an accessory (not shown) at another end thereof. As exemplarily shown, the adapter 300 includes a cylindrical housing 302 having a first end 302a and a second end 302b. The cylindrical housing 302 refers to the general shape of the housing, and deviations from a cylindrical shape are contemplated herein. Additionally, the cross-sectional shape of the cylindrical housing 302 may be circular as indicated, or any other shape understood in the art, including some variation in the cross-sectional shape along the housing axially. The adapter 300 further includes a button 303 and housing rings 314. Although the button 303 is shown at the top of the adapter 300, the button 303 may be oriented in any manner.

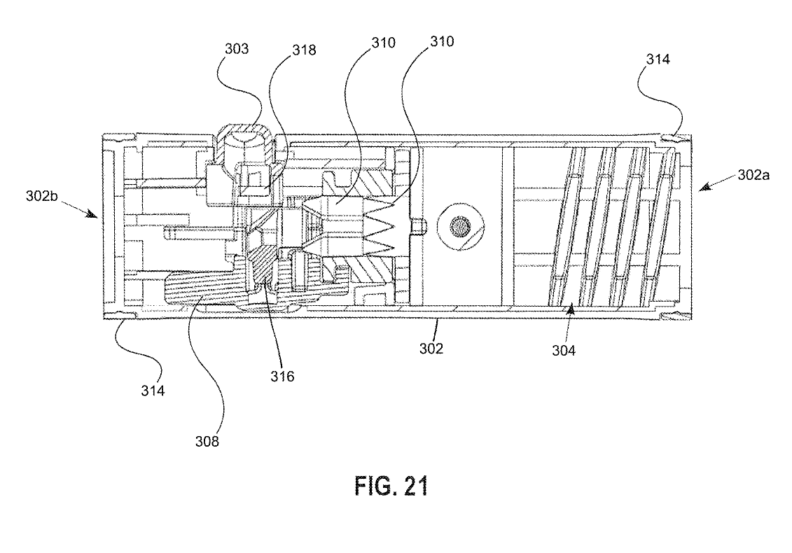

The first end 302a may include a accessory interface, e.g., a standardized accessory interface. In another embodiment, the first end includes a tool handle interface, e.g., a standardized tool handle interface. Any standardized interface may be an interface such as threaded interface 304, exemplarily illustrated in FIG. 21. As shown in FIG. 21, the first end 302a is structured to accept a threaded protrusion of an accessory (not shown). However, the first end 302a may include a threaded protrusion structured to be accepted by a tool handle or accessory, or any other type of interface understood in the art.

The second end 302b may include a tool handle interface, e.g., a specialized tool handle interface. In alternate embodiments, the second end includes an accessory interface, e.g., a specialized accessory interface. In certain embodiments, any specialized interface may include one or more engagement tabs affixed to an engagement mechanism that allows selective engagement of a specialized tool handle or accessory interface.

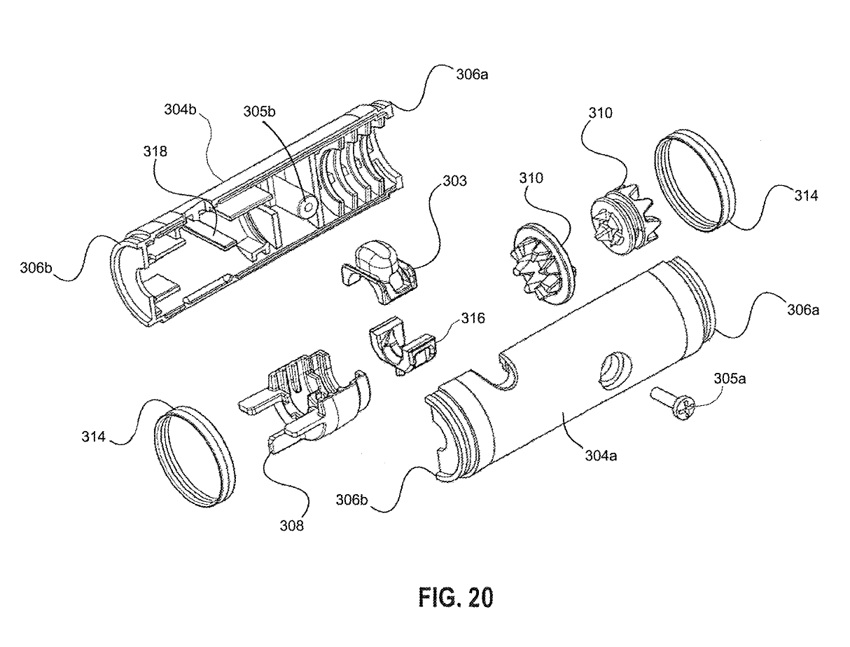

FIG. 20 is an exploded perspective view of the adapter shown in FIG. 19. FIG. 21 is a cross-section view of the adapter shown in FIG. 19.

Referring to FIGS. 20 and 21, the engagement mechanism may be provided in a similar manner as discussed above with respect to engagement mechanism 234. For example, the engagement mechanism may include a carriage 308 and locks 310. The carriage 308 may be provided in a similar manner as discussed above with respect to carriage 240. Similar to the first and second locks 248 and 250, the locks 310 include teeth that intermesh to prevent rotational movement of the adapter with a tool handle or accessory coupled thereto. Accordingly, the carriage 308 may be configured to receive a specialized tool handle or specialized accessory and be coupled to the tool handle or accessory via an interface-engaging assembly (not shown). Similar to the plunger-engaging assembly described above, the interface-engaging assembly enables the carriage 308 to be coupled to, or released from, a specialized tool handle or specialized accessory interface responsive to the engagement mechanism being engaged by a user (e.g., as when a user presses button 303).

Referring to FIG. 20, the cylindrical housing 302 is includes two opposing shells 304a and 304b that may be coupled together by any type of securing mechanism (e.g., a screw 305a and an internally-threaded post 305b). In one embodiment, each of the shells 304a and 304b includes threads 306a and 306b formed at opposite ends thereof. When the shells 304a and 304b are brought together, threads 306a on shells 304a and 304b form a functional threaded interface and threads 306b on shells 304a and 304b form another functional threaded interface. Housing rings 314 can be threaded onto the functional threaded interfaces to further secure the shells 304a and 304b together. It will nevertheless be appreciated that the shells 304a and 304b may be secured together in any other manner in addition to, or instead of, the securing mechanism described above.

In one embodiment, the tool handle or accessory may include a plunger and disc such as plunger 238 and disc 236. The carriage 308 is configured to receive the plunger and be coupled to the plunger via a plunger-engaging assembly. In the illustrated embodiment, the plunger-engaging assembly may include an integrally-formed slider/retainer 316 and a spring 318 (e.g., a beam spring). The carriage 308 may be coupled to a plunger in the following manner. A user may insert the plunger into the carriage 308, being aligned by the tabs engage grooves, slots, or other features on the tool handle (or accessory). A notch in the plunger (like notch 510 in plunger 238) functions to engage a retainer (like retainer 268) which is integrally formed with a slider (like slider 270) in slider/retainer 316. The slider/retainer 316 may be coupled to the button 303. The slider/retainer 316 and button 303 can move orthogonally relative to the longitudinal axis of the plunger. In one embodiment, the slider/retainer 316 is coupled to button 303 on one end thereof and is biased by a spring 318 on the other end thereof. When button 303 is pressed, the spring 318 is flexed downwardly and the slider/retainer 316 also moves downwardly to thereby disengage the retainer portion of the slider/retainer 316 from the notch of the plunger. When disengaged from the slider/retainer 316, the plunger can be removed from the carriage 308.

Other embodiments of the adapter described in FIGS. 19-21 that can be used to connect to a tool handle on a first end and an accessory on a second end can include similar internal mechanisms as those described above in any of FIGS. 1-18.

While locks 310 are illustrated as included within the adapter 300, it will be appreciated that other forms of locks are described above in any of FIGS. 1-18. The lock 310 distant from the engagement mechanism shown in FIG. 21 is rotationally secured to an interior wall of housing 302. The lock 310 proximate to the engagement mechanism shown in FIG. 21 is engaged with the slider/retainer 316 and button 303, which are engaged with the carriage 308. When a tool handle or accessory is connected to the carriage 308, a user can pull on the accessory or tool handle in a direction away from distant lock 310. This pulling motion will cause the proximate lock 310 to separate from the distant lock 310. The separation of the locks 310 allows the proximate lock 310 to be rotated relative the second lock 310. A spring (not shown) similar to spring 260 may be included to bias the carriage 308, and therefore the proximate lock 310 so that, when a user is not pulling on the accessory or tool handle, the proximate lock 310 will engage with the distant lock 310. The spacing and arrangement of the teeth in the locks 310 determines the number of available rotational positions for the engaging tool handle (or tool head).

While the invention has been described in connection with what is presently considered to be the most practical and preferred embodiment, it is to be understood that the invention is not to be limited to the disclosed embodiment(s), but on the contrary, is intended to cover various modifications and equivalent arrangements included within the spirit and scope of the appended claims, which scope is to be accorded the broadest interpretation so as to encompass all such modifications and equivalent structures as permitted under the law. Furthermore it should be understood that while the use of the word preferable, preferably, or preferred in the description above indicates that feature so described may be more desirable, it nonetheless may not be necessary and any embodiment lacking the same may be contemplated as within the scope of the invention, that scope being defined by the claims that follow. In reading the claims it is intended that when words such as “a,” “an,” “at least one” and “at least a portion” are used, there is no intention to limit the claim to only one item unless specifically stated to the contrary in the claim. Further, when the language “at least a portion” and/or “a portion” is used the item may include a portion and/or the entire item unless specifically stated to the contrary.

What is claimed is:

1. An adapter comprising:
a cylindrical housing having a first end and a second end;
the first end comprising a standardized tool head interface; and
the second end comprising a specialized tool handle interface and a carriage structured to allow selective engagement of the specialized tool handle interface.

2. The adapter of claim 1, wherein the cylindrical housing comprises two opposing pieces that assemble into the housing, wherein the assembled housing forms a threaded interface at each of the first end and the second end, the adapter further comprising a housing ring at each end that secure the assembled housing.

3. The adapter of claim 1, wherein the standardized tool head interface is a threaded interface.

4. The adapter of claim 1, wherein the second end further comprises at least one alignment tab structured to allow selectable alignment of the adapter with an engaged tool handle.

5. The adapter of claim 1, wherein the second end further comprises at least one alignment tab structured to ensure a correct assembly position of internal components of the adapter.

6. The adapter of claim 1, wherein the second end further comprises at least one lock structured to allow selectable alignment of the adapter with an engaged tool handle.

7. An adapter comprising:
a cylindrical housing having a first end and a second end;
the first end comprising a standardized tool handle interface; and
the second end comprising a specialized tool head interface and a carriage structured to allow selective engagement of the specialized tool head interface.
